(19) United States
(12) Patent Application Publication
(10) Pub. No.: US 2011/0187112 A1
(43) Pub. Date: Aug. 4, 2011

(54) HYDRO-KINETICALLY POWERED ELECTRICAL GENERATOR POWER HEAD

(76) Inventor: MICHAEL WAYNE BRACE, Maysville, KY (US)

(21) Appl. No.: 12/696,631

(22) Filed: Jan. 29, 2010

(51) Int. Cl. F03B 13/00; F03B 3/12

(52) U.S. Cl. 290/54; 416/131

(57) ABSTRACT

A Hydro-kinetically Powered Electrical Generator Power Head (HyPEG PH) is disclosed which converts unimpeded run-of-river, ocean and tidal flow currents into useful mechanical power on an infinitely variable scale. This innovative design can be used with other hydropower devices, especially those that are designed to remain completely submerged and require no additional permanent structures to be built on land (or in the water). This invention has no fast moving components and it has little to no ecological impact to the aquatic environment. This invention is designed to operate well below river traffic navigating on the surface and withstand foreign object damage due to debris floating under the surface. It is compliant to, and is designed to work with, other modular hydrokinetic power electrical generation systems that use vertical axis, horizontally rotating power heads from which they extract mechanical energy to convert to useful electrical energy.

### FIELD

The present disclosure relates to hydrokinetic electrical power generation, more specifically a mechanical device by which to extract mechanical energy from unimpeded flowing currents and convert that energy into rotary motion which in turn can then be converted into electrical energy.

### BACKGROUND

There are numerous hydrokinetic electrical power generators in use today that convert the current flow of rivers and oceans into useful mechanical power. But in order to achieve a commercially viable amount of electricity from these hydrokinetic electrical power generators the method commonly being used to convert the linear motion of the current into rotary motion is done through the use of hydrofoils and turbine blades fixed on to one (or more) rotating disk on a horizontal or vertical axis (the horizontal being the more common). Such is the case found in modern hydro-electrical dams and other type devices.

While in themselves hydrofoils and turbines are by no means ineffective in the conversion of linear forces to rotary forces, by their very design the majority are not very efficient and are limited in scope and breadth due to their very nature of having a vertically oriented turbine (normal to the current flow) affixed to a horizontally rotating axis. This also means that most of these hydrofoils and turbines (both vertical and horizontal axis types) are limited in diameter by the depth of the water in which they operate. Since the power derived from this method is based on the torque provided to the disk (this is a function of the diameter of the disk) and the rotational speed of the disk, this means that in order to provide substantially viable mechanical power these designs must operate with a rotating disk speed that is faster than the prevailing current speed. To increase power they have little choice other than to increase turbine blade velocity.

Due to their very nature hydrofoils and turbine disks have numerous blades with narrow leading edges. Because these blades move faster than [and are normal to] the water current they can cause severe damage to any living organism that is impacted by them during normal operation, and they themselves are easily damaged when the blades impact foreign objects. Precautions can be taken to help mitigate damage to themselves and to the aquatic life in and around these inlets (such as screens or inlet restrictions) but in addition to restricting flow (and lessening their efficiency) these ‘screens’ by no means can ensure the safety of said aquatic life during normal operations and (as often is the case) there are a numerous fish and other such organisms that are killed because of being trapped against said screens. These screens must also be periodically unclogged. This results in substantial maintenance cost with no additional benefit.

Furthermore, because hydrofoils and turbine blades must operate at faster-than-nominal current speeds they must often be accompanied by additional man-made structures, impediments and flow restriction devices (used to increase current velocity) such as dams, flues, conduits, ducts or pipes. These additional structures can add significant cost to any device, severely limiting where this technology can be applied as well as impacting the local aquatic species and environment in an adverse manner through construction and habitation damage. In many cases these impediments also require above-surface structures which in turn exposes portions of the construction to severe weather (this in turn can cause seasonal or unplanned power outages). These structures also present hazards to navigation. At the present time most other technologies are not only severely limited in where they can be placed, but they disrupt & damage the environment. Because they can impede surface traffic to an unacceptable level (and often do so in a permanent manner) most other near or above surface technologies have limited applications.

### SUMMARY

According to the present disclosure it is possible to construct and deploy a totally submerged Hydro-kinetically Powered Electrical Generator Power Head (HyPEG PH) that is not only unrestricted in where is can be placed and operated, but one that has no faster-than-current components to damage any aquatic life, one that needs no additional structures or restrictions for its normal use, one in which all components can remain totally submerged (and out of the weather), one that is more efficient at translating linear flow to rotational torque, one that is strong enough to withstand severe impacts from floating debris (and continue operating at or near design parameters) and one that is benign to the environment in which it operates; be it in inland or offshore waterways. Most importantly this present disclosure is only restricted in rotational diameter size by the width of the water way, not the depth. This allows our invention to offer significantly higher power densities than ever derived before from any other type of self-contained hydro-powered device operating in unimpeded (commonly referred to as run-of-river) water currents.

More specifically this mechanical device can be used on, and was designed to improve, those submerged electrical power generation stations which use like or similar power heads that rotate about a vertical axis.

### DRAWINGS

The drawings described herein are for illustration purposes only, the components are not scaled relative to each other, and accordingly they are not intended to limit the scope of the present disclosure in any way. The drawings presented are as follows:

FIG. 1 is a perspective view of the present disclosure.

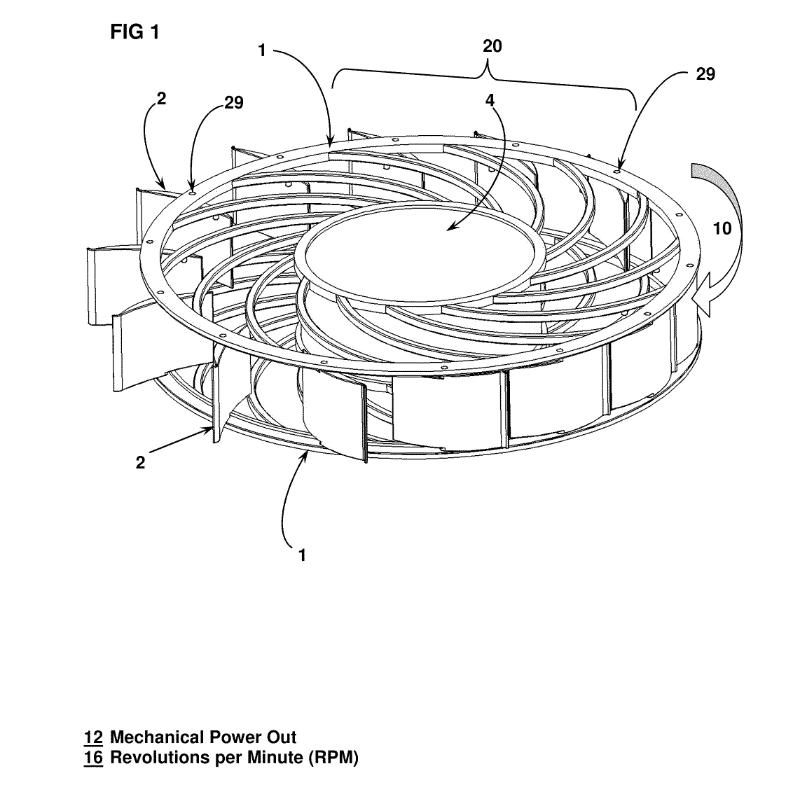

FIG. 2 is a perspective view of the present disclosure as placed in its normal operating environment, submerged completely beneath the surface of the water and in a current.

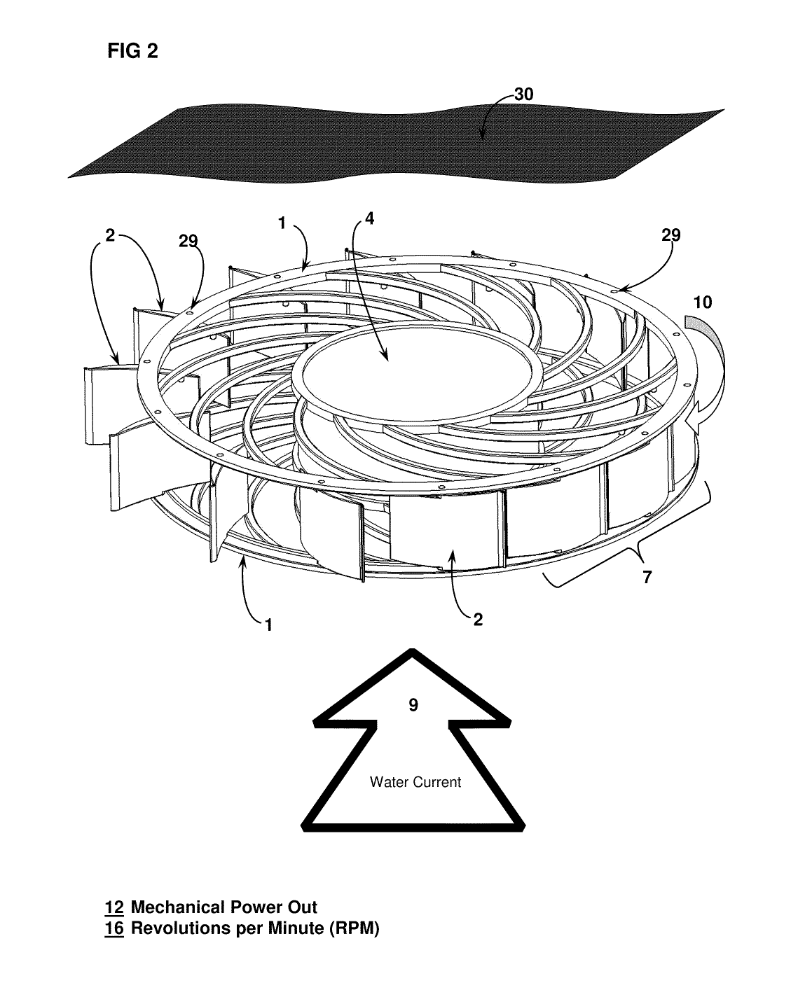

FIG. 3 is a simple schematic illustrating the relationship of the present disclosure in multiple quantities to its environment and their relationship to on-shore features.

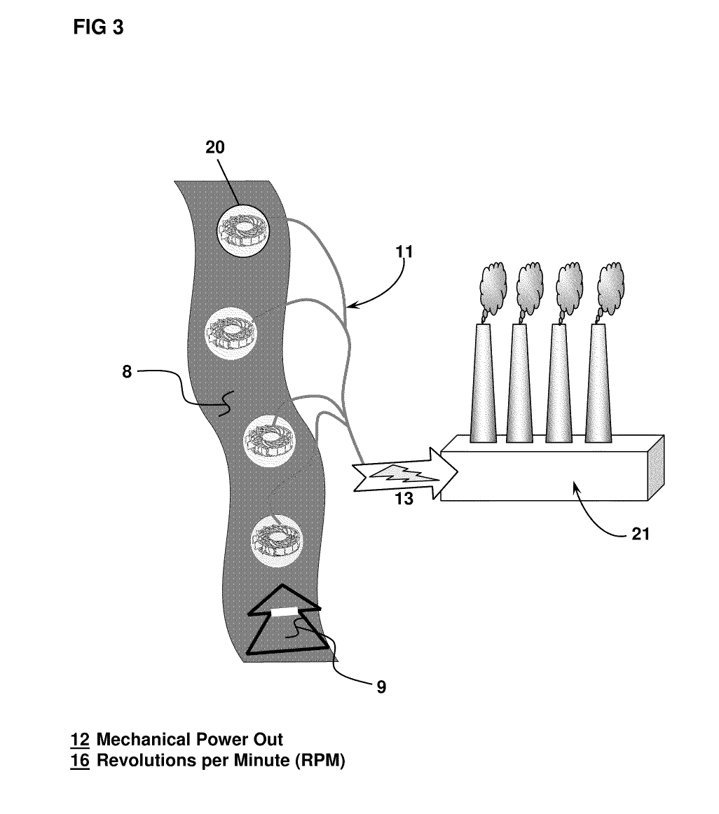

FIG. 4 is a perspective view of the present disclosure with modifications to design based on its operating environment.

FIG. 5 is a shaded perspective view of the present disclosure in its operating environment.

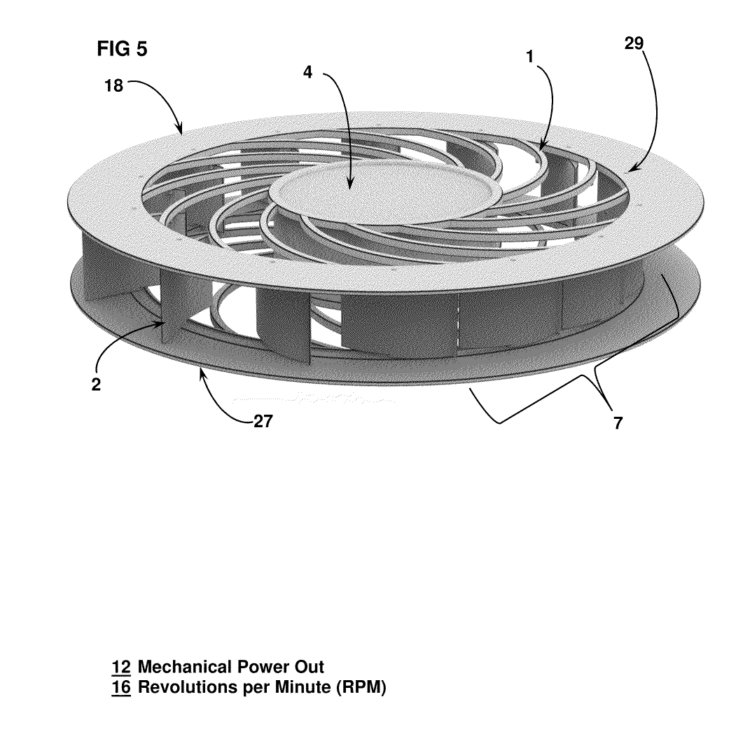

### DESCRIPTION OF THE PREFERRED EMBODIMENT

An Hydro-kinetically Powered Electrical Generator Power Head (HyPEG PH) 20 that is specifically designed to operate in unimpeded run-of-river water currents 9 such as those found in rivers 8, oceans (not pictured) or other such natural waterways (not pictured) completely submerged beneath the surface 30 in a manner such that it transfers the linear motion of flowing current 9 into rotary motion 10 through the use of a horizontally-oriented power wheel 1 that rotates about a vertical axis. The power wheel 1 has along its circumference a series of paddles 2 whose task is to provide the resistance to the current 9 flow over them [due to Form Drag] so as to cause the power wheel 1 to rotate along its vertical axis which is normal)(90°) to the current 9. This rotary motion 10 provides rotary mechanical power out 12. The paddles 2 provide the rotational torque 10 which accounts for the mechanical power out 12 from the power wheel 1. For reasons of simplicity and clarity two (2) power wheels 1 are shown, drawn with spokes, in the attached drawing(s). It is conceivable that in certain configurations only one (1) power wheel 1 may be required per HyPEG PH 20 or more than two (2) power wheels 1 can be used as well. It is understood by those skilled in the art that the number of power wheels 1, their spokes, and their physical relationship to paddles 2 can vary by design constraints.

The rotary mechanical power out 12 is a function of the difference between differential form drag created by the area profiles of those paddles 2 moving with the current 9 and those paddles 2 moving against the current 9 while the invention is rotating about its vertical axis. The greater this differential the greater the rotary mechanical power out 12 is. The governing equations that dictate the form drag (F_{D}) for the paddles 2 in non-compressible flow are as follows:

F_{D}=½C_{D}·p·V²·A_{Proj}

Where
C_{D} Coefficient of Drag of paddles 1
p (Rho) Density of water
V Current 9 velocity
A_{Proj} Projected Area of paddles 1 as seen by current 9

The governing equations that dictate the total rotary mechanical power out 10 is a variation of the above formula in paragraph [00015] that takes into account the direction of current flow on both sides of the power wheel 1 while rotating about a vertical access in a current 9. Those governing equations are:

P=Tq(total)·RPM(revolutions per minute)

Tq(total)=Tq(retreating side)−Tq(advancing side)

Tq=F_{D}·D

F_{D}(adv)=½·p·C_{D}a·2V²·A·(⅓C_{T})

F_{D}(ret)=½·p·C_{D}r·V²·A·(⅓C_{T})

Where
P Power
Tq Torque
p (Rho) Density of water
C_{D}a Coefficient of Drag of paddles 1 going against (advancing into) the current 9
C_{D}r Coefficient of Drag of paddles 1 going with (retreating with) the current 9
V Current 9 velocity
A_{Proj} Projected Area of paddles 1 as seen by current 9
D Distance from center of hub 4 to center of paddles 2
C_{T} Total number of paddles 2 per HyPEG PH 20
F_{D} (adv) Form Drag of paddles 1 going against (advancing into) the current 9
F_{D} (ret) Form Drag of paddles 1 going with (retreating with) the current 9

Analysis of the above equations illustrate that in order to maximize rotary mechanical power out 12 it is necessary to maximize the Form Drag (F_{D}) of the retreating paddles 2 (those paddles 2 going with the current 9) and minimize the Form Drag (F_{D}) of the advancing paddles 2 (those paddles 2 going against the current 9). The product of the summation of the forces results in positive rotary mechanical power out 12. The rotary mechanical power out 12 is transferred to an electrical generator (not described herein) via a mechanical connection at the hub 4 (shown, but not described herein) which is located at the center of rotation of the power wheel 1. It is understood by those skilled in the art that the design and configuration of hub 4 is such that is capable of mechanically transferring the rotational torque 10 to any properly sized electrical generator (not pictured) and that for the purpose of simplicity the design and configuration of hub 4 is not described herein, only its location.

A further disclosure of the power wheel 1 and paddle 2 assembly is that once configured to rotate in either direction (clock-wise or counter clock-wise) the will rotate in that direction with 100% effectiveness regardless of which direction the current 9 comes from. Shifting currents 9 and ebb & flow currents 9 (tidal currents 9) have no adverse effect on the operation of the power wheel 1 nor the mechanical power out 12. Once the diameter of the power wheel 1 and the number of paddles 2 and the size of the paddles 2 are determined (and placed in operation) the mechanical power out 12 is strictly based on horizontal current 9 speeds and not horizontal current 9 directions.

The diameter of the power wheel 1 is sized according to the current 9 provided so as to deliver the desired mechanical power out 12 to an electrical generator (not described herein) mechanically engaged to the hub 4 of the power wheel 1. It is also disclosed that the shape, location and surface area of paddles 2 (which are located as such at the periphery of the power wheel 1) are of such size and such shape and such design as to provide the required resistance (caused by current 9) specific to the location where the invention is submerged. In the accompanied drawings (and for illustration purposes only) the paddles 2 are illustrated as curved, vertically oriented monoliths but to those knowledgeable in the industry they could be configured to any degree of curvature, any periphery shape and any horizontal thickness to meet the desired Coefficient of Drag of the HyPEG PH 20 based on the geographic location of the invention.

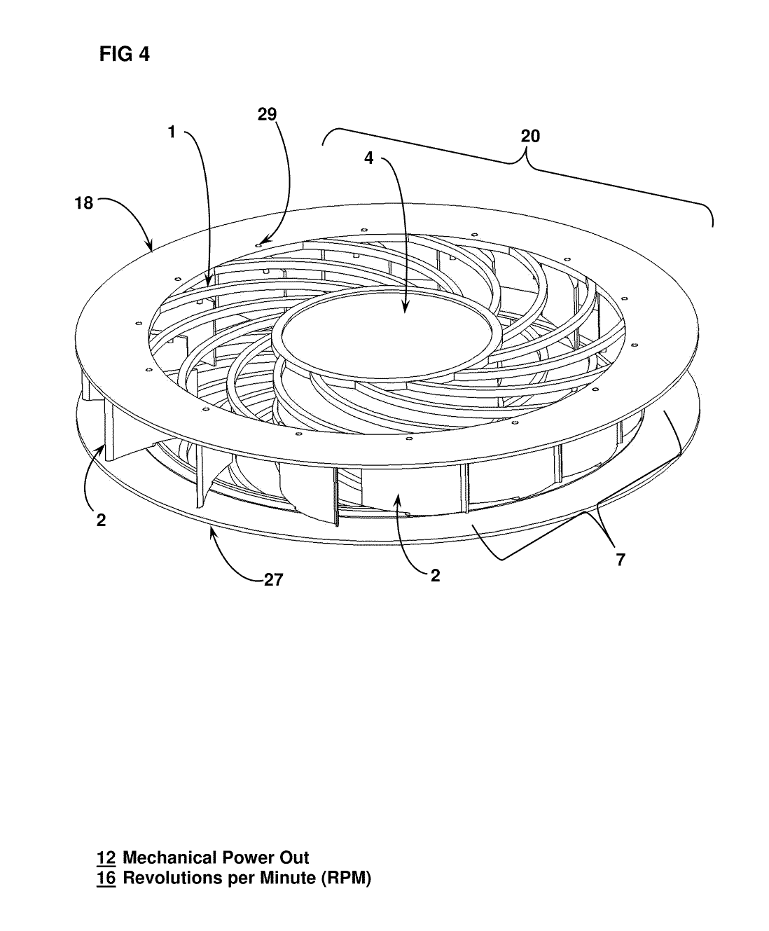

A further disclosure of the power wheel 1 is that [if desired] it can be designed to enclose the paddles 2 within an upper periphery structure 18 and/or a lower periphery structure 27 of appropriate size, shape, strength and configuration to serve as a protective barrier against foreign object damage caused by partially submerged floating debris (not pictured) being carried by current 9 that may impact power wheel 1 or paddles 2 during normal operation. In addition to providing protection against impacts, upper periphery structure 18 and/or a lower periphery structure 27 may provide additional desired hydrodynamic properties to the HyPEG PH 20. See FIG. 4 for this configuration.

The paddles 2 located along the periphery of the power wheel 1 are fixed to a vertical post hinge 29 located on (or near) the horizontally-oriented hydrodynamic center of the rotational forces 10 acting on the paddles 2 and that they are located on (or in) the structure of the paddles 2 in such a fashion as to allow the paddles 2 to rotate in and out of the horizontal plane about a vertical axis within the rotational plane of the power wheel 1 so as to provide a mechanical means of controlling the mechanical power out 12 of the rotating power wheel 1. It is understood by those skilled in the art that said vertical post hinge 29 can be configured differently as illustrated (to meet the design and scale of the paddles 2 and the needs of the power wheel 1) and that the vertical post hinge 29 are not detailed out in this disclosure but are as shown as such for illustration purposes only.

A further disclosure of this invention is that by properly locating the vertical post hinge 29 of the paddles 2 the paddles 2 can perform as ‘shutters’ 7 when rotated about their vertical axis within the rotational plane along the outer periphery of the power wheel 1. When rotated and aligned to act as ‘shutters’ 7 the paddles 2 on one side of the power wheel 1 create a profiled shape to the current 9 going against it which has a significantly lower Coefficient of Drag than those paddles 2 on the opposite side of rotation of the power wheel 1 (the side compliant with the current 9). This profile creates a significantly lower Coefficient of Drag on this side of the power wheel 1 (the side moving into the current 9) thereby increasing the torsional mechanical power out 12 significantly. It is also understood by those skilled in the art that the resistance profile created by the paddles 2 acting as ‘shutters’ 7 created [when rotated on their vertical axis] and the spacing between the paddles 2 can vary greatly by design and that this profile is designed as needed to generate the desired Coefficient of Drag for the given operational parameters.

The paddles 2 are designed, and the location of vertical post hinge 29 can be configured, to be rotated automatically about vertical post hinge 29 by those dynamic forces provide by the current 9 or they can be designed, and the location of vertical post hinge 29 configured, to be rotated about vertical post hinge 29 by supplemental mechanical means (not pictured). This configuration may be desirous so that the dynamic force exerted on paddles 2 by current 9 can be manually controlled to maintain the optimum RPM 16 of the rotating power wheel 1 for the operation of an electrical generator (not described herein) connected to hub 4 located at the center of rotation of the power wheel 1 such that the electrical generator (not pictured) can properly deliver electrical power 13 via electrical cabling 11 to an on-shore power facilities 21.

What is claimed is:

1. A hydro-kinetically powered electrical generator power head comprised of:
one or more horizontally-oriented power wheels that rotate about a vertically-oriented axis normal to current flow,
that has a plurality of hinged paddles affixed to the periphery of said power wheels,
and that has a hub located at the center of said power wheels.

2. The disclosure of claim 1 whereas said hub is configured to be mechanically connected to an electrical generator.

3. The disclosure of claim 1 whereas said paddles are of a determined plurality, size, configuration, and are located on a determined radius by:
water current speed available,
and mechanical power output required.

4. The disclosure of claim 1 whereas said paddles are hinged to rotate about a vertical axis so as to rotate in and out of the rotational plane of said power wheels by:
natural forces associated with the current in which they operate,
or by mechanical means controlled by the operator of said invention.

5. The disclosure of claim 1 whereas said paddles are of a predetermined design profile and thickness, and are hinged to rotate about a vertical axis so as to:
rotate into the rotational plane of said power wheels
and form a cylindrical wall at a predetermined circumference along the periphery of said power wheel.

6. The disclosure of claim 5 whereas the location of said axis and the amount of said rotation of said paddles about said axis to form said cylindrical wall is determined by:
the desired differential in Coefficient of Drag between opposite sides of the power wheels,
water current speed available,
and mechanical power output required [from the invention].

7. A hydro-kinetically powered electrical generator power head comprised of:
one or more horizontally-oriented power wheels that rotate about a vertically-oriented axis normal to current flow,
that has a plurality of hinged paddles affixed to the periphery of said power wheels,
that has a hub located at the center of said power wheels,
and that encloses said paddles within the outer periphery of said power wheels with an exterior structure.

8. The disclosure of claim 7 whereas said hub is configured to be mechanically connected to an electrical generator.

9. The disclosure of claim 7 whereas said paddles are of a determined plurality, size, configuration, and are located on a determined radius by:
water current speed available,
and mechanical power output required.

10. The disclosure of claim 7 whereas said paddles are hinged to rotate about a vertical axis so as to rotate in and out of the rotational plane of said power wheels by:
natural forces associated with the current in which they operate,
or by mechanical means controlled by the operator of said invention.

11. The disclosure of claim 7 whereas said paddles are of a predetermined design profile and thickness, and are hinged to rotate about a vertical axis so as to:
rotate into the rotational plane of said power wheels
and form a cylindrical wall at a predetermined circumference along the periphery of said power wheel.

12. The disclosure of claim 11 whereas the location of said axis and the amount of said rotation of said paddles about said axis to form said cylindrical wall is determined by:
the desired differential in Coefficient of Drag between opposite sides of the power wheels,
water current speed available,
and mechanical power output required [from the invention].

13. The disclosure of claim 7 whereas said external structure is configured to:
guard against foreign object damage to said paddles and said power wheels,
and provide additional enhancements to the hydrodynamic flow of the current across said paddles and said power wheels.
